(19) United States
(12) Patent Application Publication
(10) Pub. No.: US 2005/0200622 A1
(43) Pub. Date: Sep. 15, 2005

(54) Power supply circuit, driver IC using the power supply circuit, liquid crystal display device, and electronic instrument

(76) Inventor: Hidehiko Yajima, Suwa (JP)

Correspondence Address: HARNESS, DICKEY & PIERCE, P.L.C., P.O. BOX 828, BLOOMFIELD HILLS, MI, 48303, US

(21) Appl. No.: 11/063,437

(22) Filed: Feb. 23, 2005

(30) Foreign Application Priority Data
Mar. 12, 2004 (JP) 2004-070988

(51) Int. Cl. G09G 5/00

(52) U.S. Cl. 345/211

(57) ABSTRACT

A power supply circuit including a step-down circuit and a step-up circuit disposed in a following stage of the step-down circuit. The step-down circuit is connected to a first power supply line supplying a first potential VSS and also connected to a second power supply line supplying a second potential. The step-down circuit supplies a negative third potential to a third power supply line, the negative third potential having been obtained by stepping down the first potential by a difference between the first potential and the second potential. The step-up circuit is connected to the first to third power supply lines and supplies a positive fourth potential to a fourth power supply line, the positive fourth potential having been obtained by stepping up the second potential by a difference between the first potential and the third potential. The step-down circuit is formed of a switching regulator.

Japanese Patent Application No. 2004-70988, filed on Mar. 12, 2004, is hereby incorporated by reference in its entirety.

### BACKGROUND OF THE INVENTION

The present invention relates to a power supply circuit which generates a high voltage of about 40 to 60 V, a driver IC using such a power supply circuit, a liquid crystal display device, and an electronic instrument.

A display device and a power supply circuit used to drive the display device are incorporated into an electronic instrument such as a portable telephone, a portable information terminal, or a game device.

A power supply circuit used to drive such a display device generates a voltage higher than the power supply voltage supplied from a battery.

In the case of using a thin film diode (TFD) such as a metal-insulator-metal (MIM) element as a switching element of an active matrix type liquid crystal device, a high voltage of about 40 to 60 V must be supplied to a scan line connected with the thin film diode.

Japanese Patent Application Laid-open No. 2003-22062 discloses a power supply circuit for an active matrix type liquid crystal display device including a thin film transistor (TFT) as a pixel switch. This power supply circuit is provided in a data line (source line) driver IC, and supplies a voltage of 0 to 16 V to a scan line (gate line) driver IC. It is necessary to further provide a voltage conversion circuit outside the data line driver IC and the signal line driver IC. The voltage conversion circuit includes a negative power supply generation circuit which generates a negative potential of −15 to 0 V based on the voltage from the power supply circuit. A negative potential from the voltage conversion circuit is also supplied to the scan line (gate line) driver IC. As a result, a voltage of about 30 V (−15 to +16V) is supplied the scan line driver IC.

The voltage conversion circuit disclosed in Japanese Patent Application Laid-open No. 2003-22062 is provided outside the driver IC, and generates only a voltage of about 30 V. Therefore, this voltage conversion circuit cannot be used as a power supply circuit in an active matrix type liquid crystal display device including a thin film diode (TFD) as a pixel switch. In the case of generating a high voltage of about 60 V, the number of step-up stages is increased when using the charge pump disclosed in Japanese Patent Application Laid-open No. 2003-22062, whereby the circuit scale is increased.

It is extremely difficult to integrate a power supply circuit which generates a high voltage of about 60 V into an IC. Even if a high-voltage (HV) triple-well structure is used for a semiconductor substrate for integration into an IC, it is extremely difficult to form a high-voltage well. Even if a high-voltage well can be formed, process cost is increased.

### BRIEF SUMMARY OF THE INVENTION

According to a first aspect of the present invention, there is provided a power supply circuit, comprising:
a step-down circuit which is connected to first and second power supply lines respectively supplying first and second potentials and supplies a negative third potential to a third power supply line, the negative third potential having been obtained by stepping down the first potential by a difference between the first potential and the second potential; and
a step-up circuit which is connected to the first to third power supply lines and supplies a positive fourth potential to a fourth power supply line, the positive fourth potential having been obtained by stepping up the second potential by a difference between the first potential and the third potential,
wherein the step-down circuit is formed of a switching regulator.

According to a second aspect of the present invention, there is provided a driver IC, comprising:
the above-described power supply circuit; and
a scan line driver section which drives a plurality of scan lines based on a voltage from the power supply circuit.

According to a third aspect of the present invention, there is provided a liquid crystal display device, comprising:
the above-described driver IC; and
a liquid crystal display section,
wherein the liquid crystal display section includes:
the plurality of scan lines;
a plurality of data lines; and
a thin film diode and a liquid crystal element connected in series between one of the scan lines and one of the data lines; and
wherein the driver IC is connected to the scan lines of the liquid crystal display section.

According to a fourth aspect of the present invention, there is provided an electronic instrument comprising the above-described liquid crystal display device.

### BRIEF DESCRIPTION OF THE SEVERAL VIEWS OF THE DRAWING

FIG. 1 shows an example of a liquid crystal display device.

FIG. 2 is a block diagram showing a power supply circuit provided in the scan line driver IC shown in FIG. 1.

FIG. 3 is illustrative of first and second potentials supplied to the power supply circuit shown in FIG. 2 and third and fourth potentials generated by the power supply circuit.

FIG. 4 is a circuit diagram of the power supply circuit shown in FIG. 2.

FIG. 5 is a circuit diagram showing a clock signal supply system for the power supply circuit shown in FIG. 4.

FIG. 6 is an operation timing chart of the step-down circuit (switching regulator) shown in FIGS. 4 and 5.

FIG. 7 is a waveform chart of a step-up clock signal supplied to the step-up circuit shown in FIG. 5.

FIG. 8 shows a low-voltage (LV) triple-well cross-sectional structure in which elements which make up the switching regulator shown in FIGS. 4 and 5 are formed.

FIG. 9 shows a comparative example of a high-voltage (HV) triple-well cross-sectional structure.

FIG. 10 shows a portable telephone which is an example of an electronic instrument to which the present invention is applied.

FIG. 11 is a block diagram showing a modification of a power supply circuit to which a pre-step-up circuit is added.

FIG. 12 is illustrative of first and fifth potentials supplied to the power supply circuit shown in FIG. 11 and second, third, and fourth potentials generated by the power supply circuit.

FIG. 13 is a circuit diagram showing the switching regulator which makes up the pre-step-up circuit shown in FIG. 11.

### DETAILED DESCRIPTION OF THE EMBODIMENTS

Following embodiments of the present invention may provide a power supply circuit which generates a high voltage and is suitable for integration into an IC while reducing process cost, and may also provide a driver IC, a liquid crystal display device, and an electronic instrument all having the power supply circuit.

According to one embodiment of the present invention, there is provided a power supply circuit, comprising:
a step-down circuit which is connected to first and second power supply lines respectively supplying first and second potentials and supplies a negative third potential to a third power supply line, the negative third potential having been obtained by stepping down the first potential by a difference between the first potential and the second potential; and
a step-up circuit which is connected to the first to third power supply lines and supplies a positive fourth potential to a fourth power supply line, the positive fourth potential having been obtained by stepping up the second potential by a difference between the first potential and the third potential,
wherein the step-down circuit is formed of a switching regulator.

In this embodiment, the step-down circuit generates the negative third potential which is obtained by stepping down the first potential by a difference between the supplied first and second potentials. The third potential generated by the step-down circuit and the first and second potentials are supplied to the step-up circuit. The step-up circuit generates the fourth potential which is obtained by stepping up the second potential by a difference between the first potential and the third potential. Therefore, the power supply circuit can generate a high voltage which is a potential difference between the positive fourth potential and the negative third potential. Since the step-down circuit is formed of a switching regulator, the number of capacitor parts is reduced in comparison with the case in which the step-down circuit is formed of a multi-stage charge pump. So the number of external parts is reduced when providing the power supply circuit in an IC, whereby integration into an IC can be achieved at low cost. Moreover, since the number of switching elements is reduced in comparison with a multi-stage charge pump, current consumption can be reduced.

In this power supply circuit, the switching regulator may include:
an inductor element having one end connected to the first power supply line;
a diode having a cathode connected to the other end of the inductor element and also having an anode connected to the third power supply line;
a first switching element which is connected to the second poser supply line and a node between the inductor element and the diode, and is ON/OFF controlled based on a clock signal; and
a first capacitor disposed between the first and third power supply lines and connected in parallel to the inductor element and the diode.

In the switching regulator, when the first switching element is turned ON, energy (electric charge) for generating an induced electromotive force is stored in the inductor element due to the current flowing through the inductor element. When the first switching element is turned OFF, the electric charge stored in the inductor element based on the difference between the first and second potentials is moved toward the first capacitor through the first power supply line. This causes the negative third potential to be generated based on the first potential, at the terminal of the first capacitor on the side of the third power supply line. Moreover, since a reverse current does not flow through the inductor element due to the presence of the diode, the negative third potential is maintained on the third power supply line.

In this power supply circuit, the first switching element may be a P-type transistor formed on a P-type semiconductor substrate which has a triple-well structure; a first layer well in a lowermost section of the P-type semiconductor substrate may be a high voltage resistant N-type well; a second layer well formed in the first layer well may be a low voltage resistant N-type well; and source and drain logic wells of the P-type transistor may be formed in the second layer well.

Since the second layer well can be formed of a low-voltage well, a low-voltage (LV) triple-well structure is formed. Therefore, process cost is reduced in comparison with a high-voltage (HV) triple-well structure and the layout area of the element is reduced, whereby integration into an IC is facilitated.

In this power supply circuit, an N-type contact may be provided in the low voltage resistant N-type well; and the second power supply line may be connected to the source logic well and the N-type contact.

In this power supply circuit, the P-type semiconductor substrate may include a high voltage resistant P-type well provided adjacent to the high voltage resistant N-type well, and also include an N-type well disposed in the high voltage resistant P-type well; and the diode may be formed of a PN junction between the high voltage resistant P-type well and the N-type well.

The diode may be formed outside the semiconductor substrate.

In this power supply circuit, a P-type contact may be provided in the high voltage resistant P-type well; and the third power supply line may be connected to the P-type contact.

In this power supply circuit, the N-type well may be connected to the drain logic well through an interconnect.

The first switching element and the diode can be thus formed on the P-type semiconductor substrate. In this case, the second layer well (low voltage resistant N-type well) is set at the second potential, and the high voltage resistant P-type well and the P-type semiconductor substrate are set at the negative third potential. However, the first layer well (high voltage resistant N-type well) exists between the second layer well and the P-type semiconductor substrate and exists between the second layer well and the high voltage resistant P-type well. Therefore, since a high voltage is not applied between the first layer well and the second layer well, the second layer well can be formed as a low-voltage type.

In this power supply circuit, the step-up circuit may be a charge pump.

In this power supply circuit, the charge pump may include:
second and third switching elements which are connected in series between the first and fourth power supply lines and are driven complementarily;
fourth and fifth switching elements which are connected in series between the second and third power supply lines and are driven complementarily;
a second capacitor connected to a node between the second and third switching elements and a node between the fourth and fifth switching elements; and
a third capacitor connected between the third and fourth power supply lines.

When the third and fifth switching elements are turned ON, an electric charge based on the difference between the first and third potentials is stored in the second capacitor. When the second and fourth switching elements are turned ON, since one end of the second capacitor is shifted to the second potential, the step-up fourth potential occurs at the other end of the second capacitor, that is, on the fourth power supply line. An electric charge based on the difference between the third and fourth potentials is stored in the third capacitor.

In this power supply circuit, the first potential may be a ground power supply potential (VSS), and the second potential may be a logic power supply potential (VDD).

The power supply circuit may further comprise: a pre-step-up circuit disposed in a preceding stage of the step-down circuit; and a fifth power supply line,
wherein the pre-step-up circuit is connected to the first and fifth power supply lines, and supplies the second potential to the second power supply line, the second potential having been obtained by stepping up the first potential by a difference between the first and fifth potentials.

In this power supply circuit, the pre-step-up circuit may be formed of another switching regulator or a charge pump.

In this power supply circuit, the first potential may be a ground power supply potential (VSS), and the fifth potential may be a logic power supply potential (VDD).

In this case, the second potential may be set at a potential higher than the potential VDD.

According to one embodiment of the present invention, there is provided a driver IC, comprising:
the above-described power supply circuit; and
a scan line driver section which drives a plurality of scan lines based on a voltage from the power supply circuit.

According to one embodiment of the present invention, there is provided a liquid crystal display device, comprising:
the above-described driver IC; and
a liquid crystal display section,
wherein the liquid crystal display section includes:
the plurality of scan lines;
a plurality of data lines; and
a thin film diode and a liquid crystal element connected in series between one of the scan lines and one of the data lines; and
wherein the driver IC is connected to the scan lines of the liquid crystal display section.

According to one embodiment of the present invention, there is provided an electronic instrument comprising the above-described liquid crystal display device.

These embodiments of the present invention will be described below with reference to the drawings.

1. Liquid Crystal Display Device and Scan Line Driver

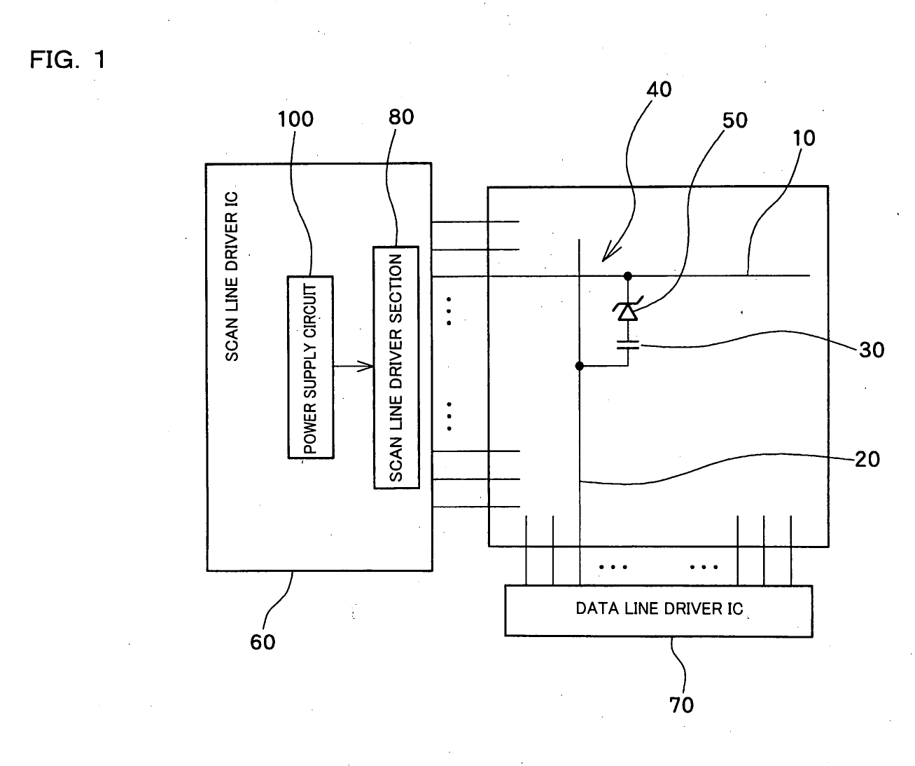

FIG. 1 shows an example of a liquid crystal display device. A plurality of scan lines 10 extending in the lateral direction are formed on one of a pair of substrates, and a plurality of data lines 20 extending in the longitudinal direction are formed on the other substrate. A liquid crystal 30 is sealed between the substrates. A thin film diode (TFD) is formed in each pixel region 40 on one of the substrates as a pixel switch which is connected with the scan line 10 at one end and is connected with the liquid crystal 30 at the other end. A metal-insulator-metal (MIM) element may be used as the thin film diode 50, for example.

FIG. 1 shows a scan line driver IC 60 which drives the scan lines 10 and a data line driver IC 70 which drives the data lines 20. A power supply circuit of the present invention is provided in the scan line driver IC 60 which must supply a high voltage of 50 V or more, for example. As shown in FIG. 1, the scan line driver IC 60 includes a power supply circuit 100 and a scan line driver section 80 which drives the scan lines 10 based on the voltage from the power supply circuit 100.

2. Power Supply Circuit

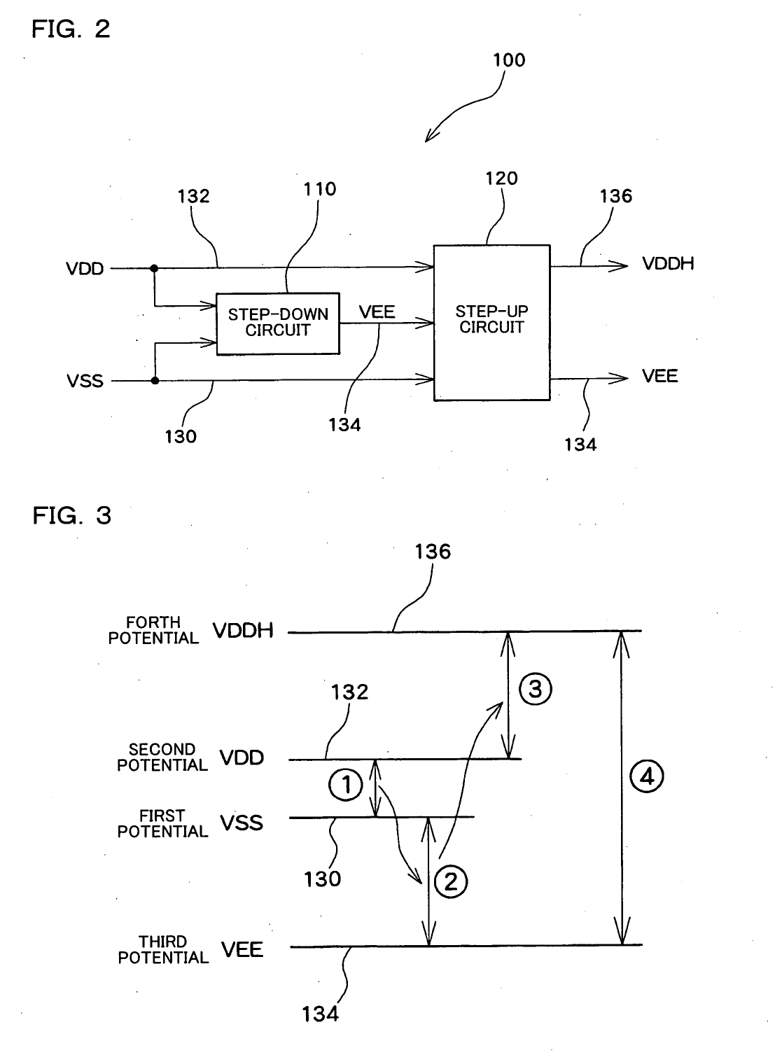

FIG. 2 shows an example of the power supply circuit 100 provided in the scan line driver IC 60 shown in FIG. 1. The power supply circuit 100 shown in FIG. 2 includes a step-down circuit 110 and a step-up circuit 120. A first power supply line 130, a second power supply line 132, a third power supply line 134, and a fourth power supply line 136 are connected with the power supply circuit 100. FIG. 3 shows an example of potentials of the first to fourth power supply lines 130 to 136. A first potential supplied to the first power supply line 130 is a ground power supply potential (VSS), and a potential supplied to the second power supply line 132 is a logic power supply potential (VDD).

The step-down circuit 110 is connected with the first power supply line 130 which supplies the first potential VSS and the second power supply line 132 which supplies the second potential VDD, and supplies a negative third potential VEE which is stepped down with respect to the first potential VSS based on the difference between the first potential and the second potential (VDD−VSS) to the third power supply line 134.

The step-up circuit 120 is connected with the first to third power supply lines 130 to 134, and supplies a positive fourth potential VDDH which is stepped up with respect to the second potential VDD based on the difference between the first potential and the third potential (VSS−VEE) to the fourth power supply line 136.

In this embodiment, VSS is 0 V, VDD is +5 V, VEE is −25 V, and VDDH is +55 V. However, these potentials are only examples.

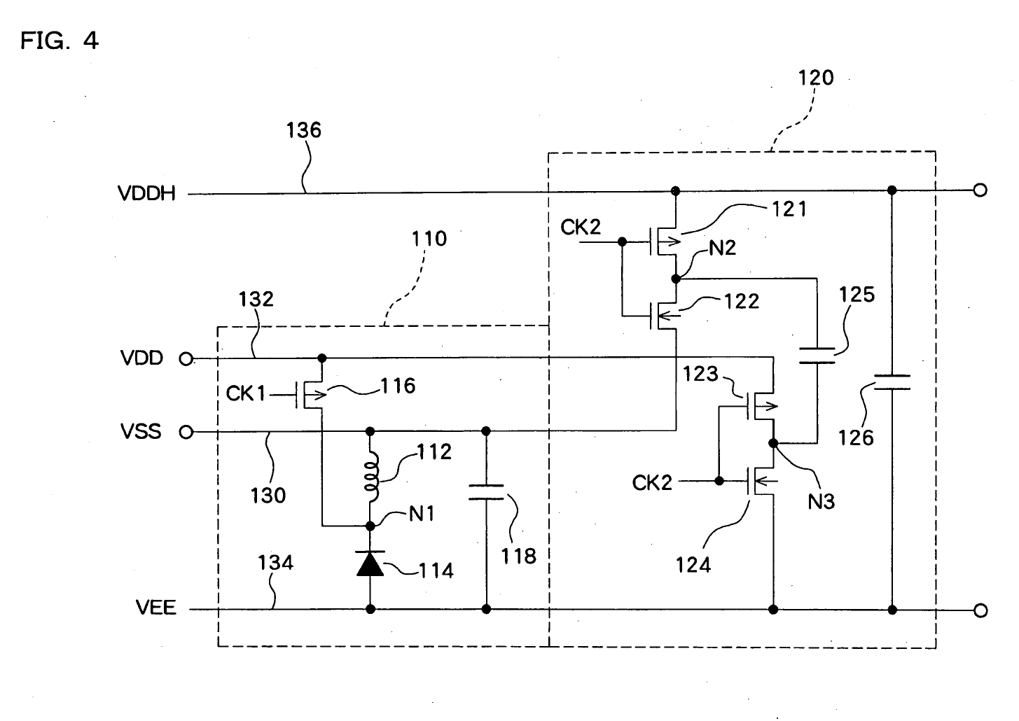

FIG. 4 is a circuit diagram in which the step-down circuit 110 is formed of a switching regulator and the step-up circuit 120 is formed of a charge pump. The switching regulator 110 includes a coil (inductor element) 112, a diode 114, a first switching transistor (first switching element) 116, and a first capacitor 118. One end of the coil 112 is connected with the first power supply line 130. The diode 114 is reverse-connected in series with the coil 112 between the first and third power supply lines 130 and 134. Specifically, a cathode of the diode 114 is connected with the other end of the coil 112, and an anode of the diode 114 is connected with the third power supply line 134. The first switching transistor 116 is a P-type transistor which is connected with a node N1 between the inductor element 112 and the diode and the second power supply line 132 and is ON/OFF controlled based on a first clock signal CK1. The first capacitor 118 is connected in parallel with the inductor element 112 and the diode 114 between the first and third power supply lines 130 and 134. The third potential VEE of the third power supply line 136 is smoothed by the first capacitor 118.

The charge pump 120 includes second to fifth switching transistors (second to fifth switching elements) 121 to 124 and second and third capacitors 125 and 126. The second and third switching transistors 121 and 122 are connected in series between the first and fourth power supply lines 130 and 136, and are driven complimentarily. The fourth and fifth switching transistors 123 and 124 are connected in series between the second and third power supply lines 132 and 134, and are driven complimentarily. The second and fourth switching transistors 121 and 123 are formed of P-type transistors, and the third and fifth switching transistors 122 and 124 are formed of N-type transistors.

The second capacitor 125 is connected with a node N2 between the second and third switching transistors 121 and 122 and a node N3 between the fourth and fifth switching transistors 123 and 124. The third capacitor 126 is connected between the third and fourth power supply lines 134 and 136.

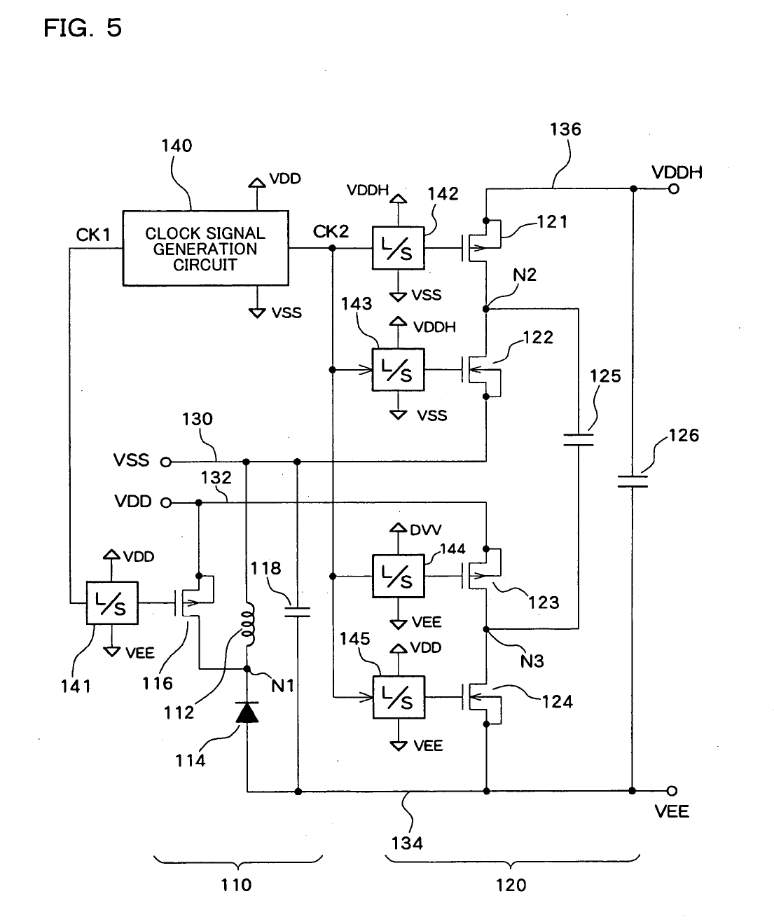

FIG. 5. shows a clock supply system which supplies the first and second clock signals CK1 and CK2 to the step-down and step-up circuits 110 and 120. A clock signal generation circuit 140 generates the first and second clock signals CK1 and CK2 based on the first and second potentials VSS and VDD. A first level shifter 141 level-shifts the first clock signal CK1 to the voltage between the second and third potentials (VDD−VEE), and supplies the resulting signal to a gate of the first switching transistor 116. Second and third level shifters 142 and 143 level-shift the second clock signal CK2 to the voltage between the first and fourth potentials (VDDH-VSS), and supply the resulting signal to gates of the second and third switching transistors 121 and 122, respectively. Fourth and fifth level shifters 144 and 145 level-shift the second clock signal CK2 to the voltage between the second and third potentials (VDD−VEE), and supply the resulting signal to gates of the fourth and fifth switching transistors 123 and 124, respectively. The third and fifth level shifters 143 and 145 may be omitted. In this case, the second level shifter 142 may be used for the second and third switching transistors 121 and 122, and the fourth level shifter 144 may be used for the fourth and fifth switching transistors 123 and 124.

3. Operation of Step-Down Circuit

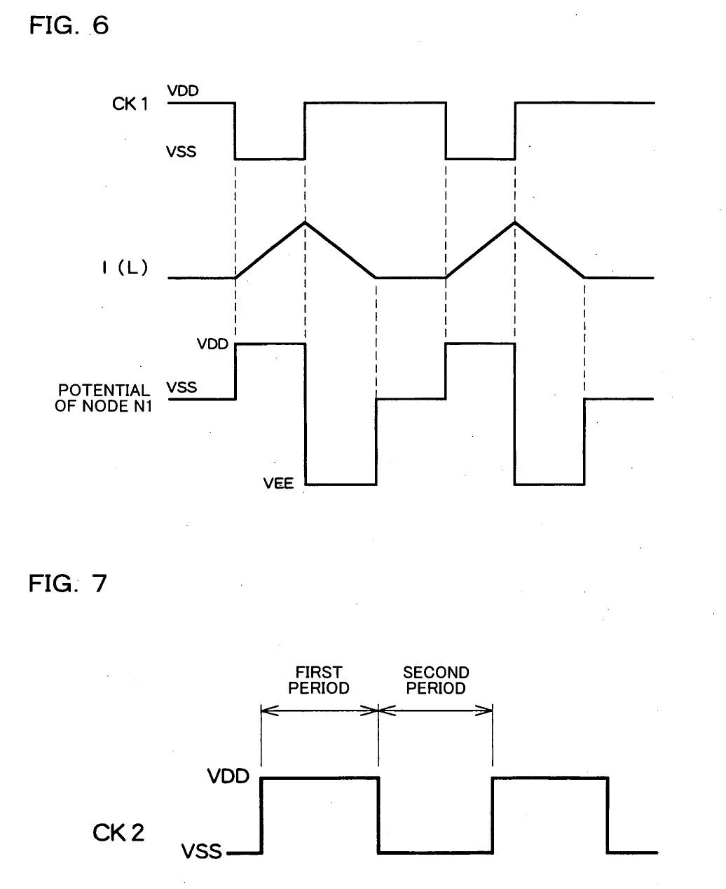

FIG. 6 is an operation timing chart of the step-down circuit (switching regulator) 110 shown in FIGS. 4 and 5. The first clock signal CK1 shown in FIG. 6 is level-shifted and input to the gate of the first switching transistor 116 shown in FIG. 5. Since the first switching transistor 116 is a P-type transistor, the first switching transistor 116 is turned ON when the first clock signal CK1 is set at LOW and is turned OFF when the first clock signal CK1 is set at HIGH.

When the first switching transistor 116 is turned ON, the potential of the node N1 is set at the second potential VDD. Therefore, a current I (L) flows through the coil 112 via the first switching transistor 116 (see FIG. 6). In this case, energy (electric charge) for generating an induced electromotive force in the coil 112 is stored in the coil 112. Since the potentials VDD and VSS are 0 V before the power supply circuit 100 is driven, the potential of the third power supply line 134 in the initial state is the ground potential. Therefore, since a reverse voltage is applied across the diode 114 when the first switching transistor 112 is turned ON, the diode 114 does not conduct electricity.

When the first clock signal CK1 is set at HIGH, the first switching transistor 116 is turned OFF. In this case, the current I (L) flows until the electric charge stored in the coil 112 is transferred to the first capacitor 118 (see FIG. 6). Since the induced electromotive force occurs in the coil 112 in the direction which prevents the flow of the current I (L), the step-down potential (inversion step-up potential) VEE which is negative with respect to the first potential (VSS) of the first power supply line 130 occurs on the third power supply line 134 due to the induced electromotive force. The diode 114 conducts electricity only in a period in which the current I (L) flows and sets the potential of the node N1 at the third potential VEE (see FIG. 6). The diode 114 does not conduct electricity in the remaining period, and the reverse current of the current I (L) does not occur.

The third potential VEE of the third power supply line 134 is smoothed by the first capacitor 118 by repeating the ON/OFF operation of the first switching transistor 116.

The step-down circuit (switching regulator) 110 thus supplies the negative third potential VEE which is stepped down with respect to the first potential VSS based on the difference between the first potential and the second potential (VDD−VSS) to the third power supply line 134.

4. Operation of Step-up Circuit

FIG. 7 is a waveform chart of the second clock signal (step-up clock signal) CK2 shown in FIG. 5. In a first period in which the second clock signal CK2 is set at HIGH, the second and fourth switching transistors 121 and 123 are turned OFF, and the third and fifth switching transistors 122 and 124 are turned ON. Therefore, one end of the second capacitor 125 is connected with the first power supply line 130 through the third switching transistor 122, and the other end of the second capacitor 125 is connected with the third power supply line 134 through the fifth switching transistor 124. This causes the voltage corresponding to the potential difference (VSS-VEE) to be applied across the second capacitor 125, whereby an electric charge corresponding to the potential difference is stored in the second capacitor 125.

In a second period subsequent to the first period, the second clock signal CK2 is set at LOW. Therefore, the second and fourth switching transistors 121 and 123 are turned ON, and the third and fifth switching transistors 122 and 124 are turned OFF.

Therefore, one end of the second capacitor 125 is connected with the fourth power supply line 136 through the second switching transistor 121, and the other end of the second capacitor 125 is connected with the second power supply line 132 through the fourth switching transistor 123.

In the second period, since the potential of the other end of the second capacitor 125 which has stored the electric charge corresponding to the potential difference (VSS−VEE) is shifted from the third potential VEE to the second potential VDD, the potential of one end of the second capacitor 125 is also shifted to the same extent.

Therefore, a step-up potential (VSS−VEE+VDD) occurs as the fourth potential VDDH of the fourth power supply line 136 connected with one end of the second capacitor 125. Suppose that VSS=0 V, VDD=+5 V, and VEE=−25 V, the third potential VDDH is +30 V. The potential difference between the third and fourth power supply lines 134 and 136 is (VDDH−VEE)=30−(−25)=+55 V. The potential difference (VDDH−VEE) is maintained across the third capacitor 126 by repeating the operations in the first and second periods. A high voltage V (VDDH−VEE) is thus generated in the power supply circuit 100 shown in FIG. 2 based on the first and second potentials VSS and VDD.

5. Cross-sectional Structure of Power Supply Circuit

Among the elements shown in FIG. 5, the coil 112 and the first to third capacitors 118, 125, and 126 are externally provided to the scan line driver IC 60. The remaining elements may be formed on a semiconductor substrate.

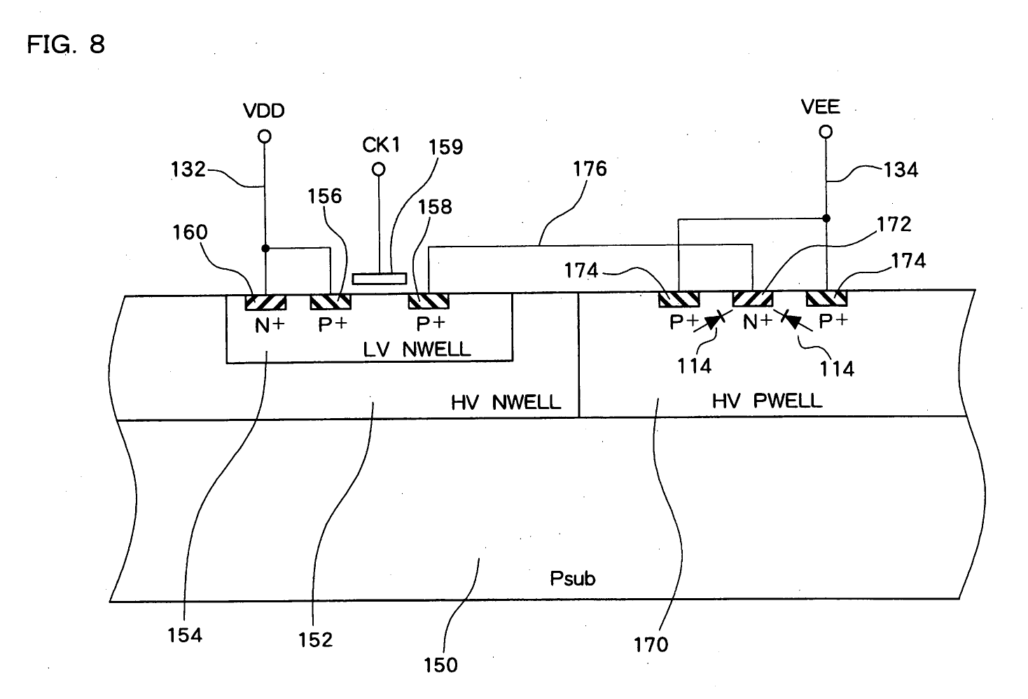

FIG. 8 shows a cross-sectional structure of the first switching transistor (P-type transistor) 116 and the diode 114 shown in FIG. 5. The P-type transistor 116 is formed on a p-type semiconductor substrate 150 having a low-voltage (LV) triple-well structure.

A first layer well 152 in the lowermost section of the transistor formation region on the p-type semiconductor substrate 150 is a high voltage resistant N-type well. A second layer well 154 formed in the first layer well 152 is a low voltage resistant N-type well. A source logic well 156 and a drain logic well 158 of the P-type transistor 116 are formed in the second layer well 154. A gate 159 is formed at a position opposite to a channel region between the source logic well 156 and the drain logic well 158 through a gate insulating layer. An N-type contact 160 is formed in the second layer well 154. The second power supply line 132 is connected with the N-type contact 160 and the source logic well 156.

A high voltage resistant P-type well 170 is formed in the p-type semiconductor substrate 150 adjacent to the high voltage resistant N-type well 152. An N-type well 172 is formed in the high voltage resistant P-type well 170. The diode 114 is formed by the PN junction between the high voltage resistant P-type well 170 and the N-type well 172.

A P-type contact 174 is formed in the high voltage resistant P-type well 170, and the third power supply line 134 is connected with the P-type contact. The N-type well 172 is connected with the drain logic well 158 through an interconnect 176.

The second layer well 154 which is set at the second potential VDD (+5 V, for example) through the N-type contact 160 is isolated from the high voltage resistant P-type well 170 which is set at the third potential VEE (−25 V, for example) through the P-type contact 174 via the first layer well (high voltage resistant N-type well) 152. Therefore, the second layer well 154 can be formed of a low voltage resistant N-type well instead of a high-voltage well.

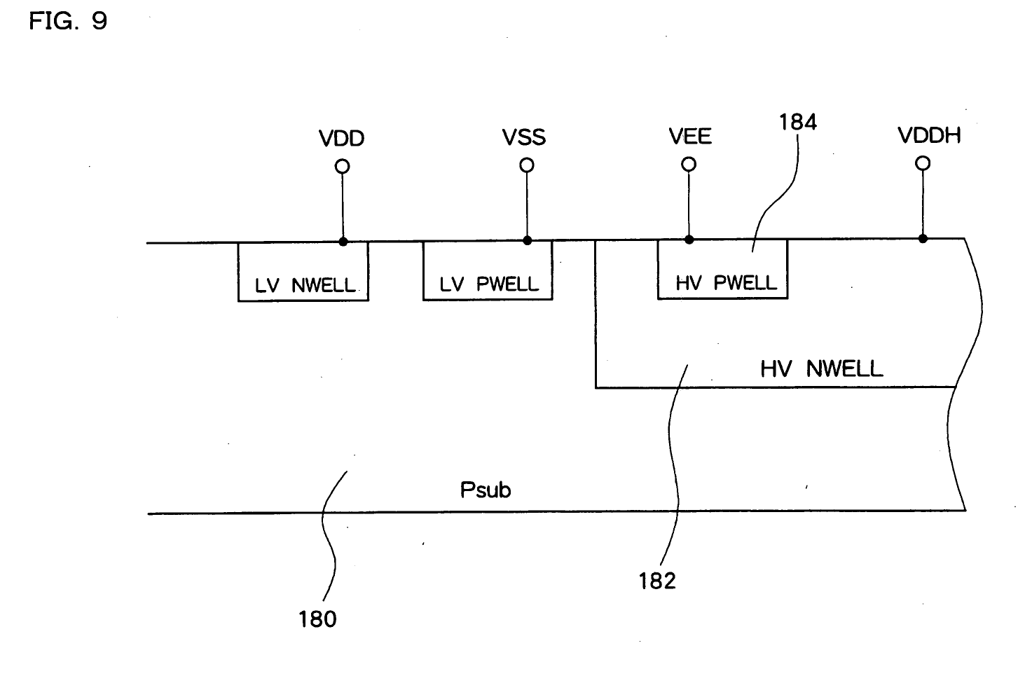

In a high-voltage (HV) triple-well structure, a P-type semiconductor substrate 180 is set at the first potential (VSS) as shown in FIG. 9. Therefore, a first layer well 182 is set at the fourth potential VDDH (+30 V, for example) which is higher than the potential of the P-type semiconductor substrate 180, and a second layer well 184 formed in the first layer well 182 is set at the third potential VEE (−25 V, for example). Therefore, it is necessary to form the first layer well 182 using a high voltage resistant N-type well and to form the second layer well 184 formed in the first layer well 182 using a high voltage resistant P-type well.

In this embodiment, since the second layer well 154 can be formed using a low-voltage well, process cost can be reduced.

As another effect of this embodiment, since the step-down circuit 110 is formed of a switching regulator, the layout area can be reduced in comparison with the case of forming the step-down circuit 110 using a multi-stage charge pump. In a multi-stage charge pump which generates a voltage four times the supply voltage, at least four switching transistors must be provided in the IC. On the other hand, in the switching regulator 110, it suffices to provide one switching transistor 116 and one diode 114 in the IC as shown in FIG. 4.

As external parts for the IC, one coil 112 and one capacitor 118 are necessary in the switching regulator 110, and at least four capacitors are necessary in a four-fold step-down multi-stage charge pump. Therefore, the number of external parts is reduced. The number of external parts is reduced even if the diode 114 shown in FIG. 4 is externally provided.

In the power supply circuit 100 in this embodiment, current consumption is also reduced. Specifically, only one switching transistor 116 is necessary in the switching regulator 110. On the other hand, since at least four switching transistors are necessary in a four-fold step-down multi-stage charge pump, current consumption is increased due to an increase in charge/discharge current.

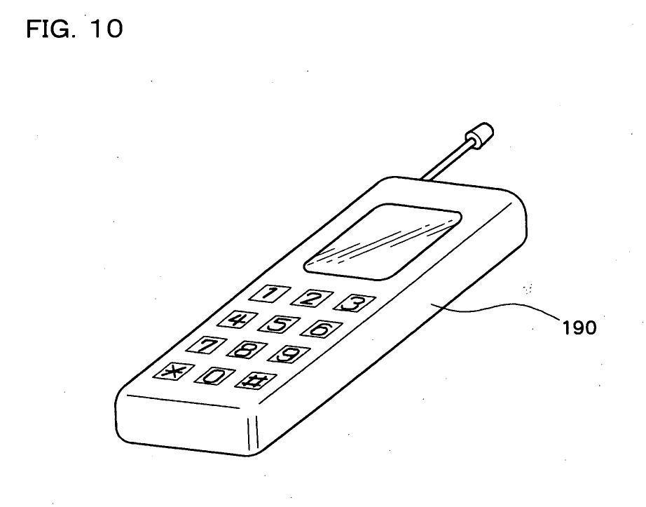

Therefore, power consumption of an electronic instrument including a display device in this embodiment can be reduced. It is particularly suitable to use the display device in this embodiment for a battery-driven portable instrument such as a portable telephone 190 shown in FIG. 10.

The present invention is not limited to the above-described embodiments. Various modifications and variations may be made within the scope of the present invention. For example, the step-up circuit 120 provided in the subsequent stage of the step-down circuit 110 is not limited to the configuration shown in FIGS. 4 and 5. The step-up factor may be increased by using a multi-stage charge pump as the step-up circuit 120, for example.

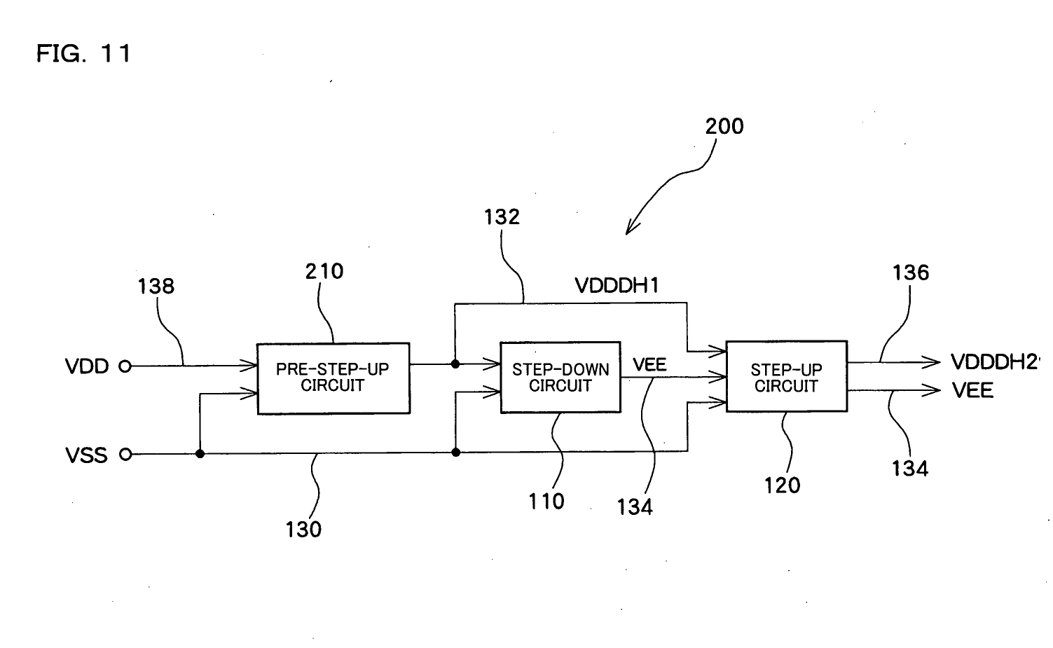

FIG. 11 is a block diagram of a power supply circuit 200 in which a pre-step-up circuit 210 is added to the preceding stage of the step-down circuit 110. In FIG. 11, sections having the same functions as in FIG. 2 are indicated by the same symbols. In FIG. 11, the first potential VSS and a fifth potential VDD are supplied to the pre-step-up circuit 210. In FIG. 11, the second potential is indicated by VDDH1 and the fourth potential is indicated by VDDH2.

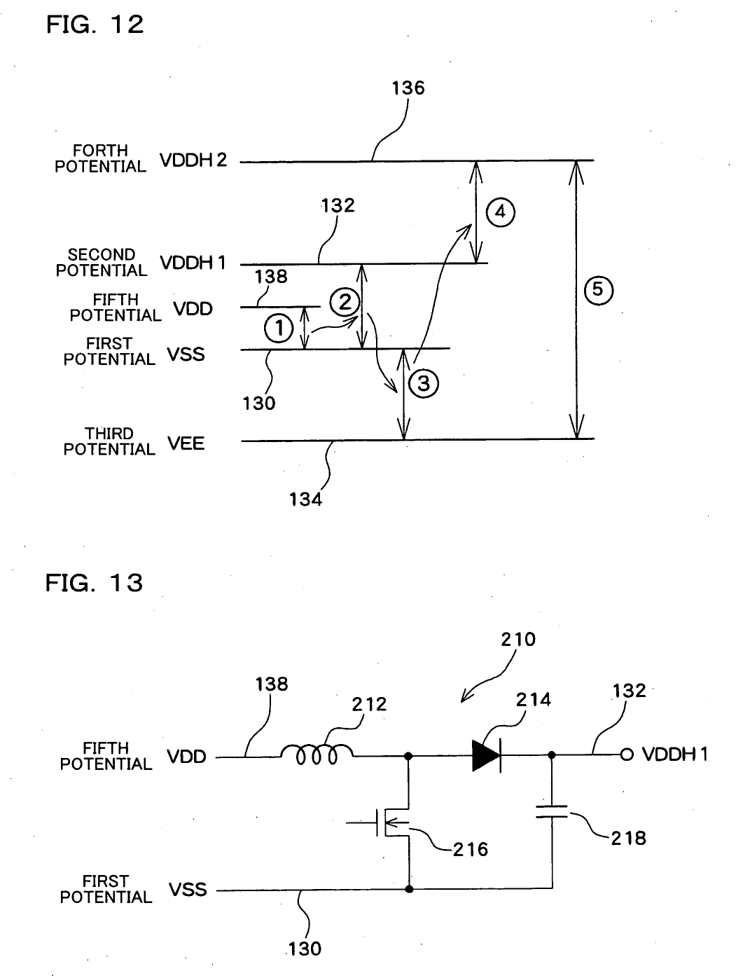

FIG. 12 is a diagram illustrative of the first potential VSS and the fifth potential VDD supplied to the power supply circuit shown in FIG. 11 and the second potential VDDH1, the third potential VEE, and the fourth potential VDDH2 generated by the power supply circuit 200. For example, the first potential VSS is 0 V (ground power supply potential) and the fifth potential VDD is 5 V (logic power supply potential).

The pre-step-up circuit 210 shown in FIG. 1 is connected with the first power supply line 130 and a fifth power supply line 138, and supplies the second potential VDDH1 which is stepped up with respect to the first potential VSS based on the difference between the first potential VSS and the fifth potential VDD to the second power supply line 132. The step-down circuit 110 and the step-up circuit 120 have the same configurations as described above. In this case, since the second potential VDDH 1 supplied to the step-down circuit 110 and the step-up circuit 120 is higher than the logic power supply potential VDD, the absolute values of the third potential VEE and the fourth potential VDDH2 can be increased in comparison with FIG. 3.

The pre-step-up circuit 210 may be formed of a switching regulator or a charge pump. FIG. 13 is a circuit diagram showing an example of a switching regulator which makes up the pre-step-up circuit 210. The switching regulator 210 includes an inductor element (coil) 212, a diode 214, a switching transistor 216, and a capacitor 218. One end of the coil 212 is connected with the fifth power supply line 138. An anode of the diode 214 is connected with the other end of the coil 212, and a cathode of the diode 214 is connected with the second power supply line 132. The switching transistor 216 is an N-type transistor. A source of the switching transistor 216 is connected with the first power supply line 130, and a drain of the switching transistor 216 is connected with a node between the coil 212 and the diode 214. The capacitor 218 is connected between the first power supply line 130 and the second power supply line 132.

The switching transistor 210 is turned ON when a clock signal input to a gate of the switching transistor 216 is set at HIGH, whereby current flows through the fifth power supply line 138, the coil 212, the switching transistor 216, and the first power supply line 130 in that order. This current causes energy (electric charge) for generating an induced electromotive force to be stored in the coil 212. The switching transistor 210 is turned OFF when the clock signal is set at LOW. However, since the diode 214 conducts electricity, the electric charge stored in the coil 212 is moved toward the capacitor 218, whereby the second potential VDDH1 which is the step-up potential occurs on the second power supply line 132. Since the potential of the second power supply line 132 is 0 V in the initial state after the power is supplied, the diode 214 conducts electricity irrespective of whether the switching transistor 216 is turned ON or OFF until the second potential VDDH1 becomes equal to or higher than the potential VDD due to the progress of the step-up operation.

Although only some embodiments of the present invention have been described in detail above, those skilled in the art will readily appreciate that many modifications are possible in the embodiments without departing from the novel teachings and advantages of this invention. Accordingly, all such modifications are intended to be included within the scope of this invention.

1. A power supply circuit, comprising:
a step-down circuit which is connected to first and second power supply lines respectively supplying first and second potentials and supplies a negative third potential to a third power supply line, the negative third potential having been obtained by stepping down the first potential by a difference between the first potential and the second potential; and
a step-up circuit which is connected to the first to third power supply lines and supplies a positive fourth potential to a fourth power supply line, the positive fourth potential having been obtained by stepping up the second potential by a difference between the first potential and the third potential,
wherein the step-down circuit is formed of a switching regulator.

2. The power supply circuit as defined in claim 1,
wherein the switching regulator includes:
an inductor element having one end connected to the first power supply line;
a diode having a cathode connected to the other end of the inductor element and also having an anode connected to the third power supply line;
a first switching element which is connected to the second poser supply line and a node between the inductor element and the diode, and is ON/OFF controlled based on a clock signal; and
a first capacitor disposed between the first and third power supply lines and connected in parallel to the inductor element and the diode.

3. The power supply circuit as defined in claim 2, wherein:
the first switching element is a P-type transistor formed on a P-type semiconductor substrate which has a triple-well structure;
a first layer well in a lowermost section of the P-type semiconductor substrate is a high voltage resistant N-type well;
a second layer well formed in the first layer well is a low voltage resistant N-type well; and
source and drain logic wells of the P-type transistor are formed in the second layer well.

4. The power supply circuit as defined in claim 3, wherein:
an N-type contact is provided in the low voltage resistant N-type well; and
the second power supply line is connected to the source logic well and the N-type contact.

5. The power supply circuit as defined in claim 4, wherein:
the P-type semiconductor substrate includes a high voltage resistant P-type well provided adjacent to the high voltage resistant N-type well, and also includes an N-type well disposed in the high voltage resistant P-type well; and
the diode is formed of a PN junction between the high voltage resistant P-type well and the N-type well.

6. The power supply circuit as defined in claim 5, wherein:
a P-type contact is provided in the high voltage resistant P-type well; and
the third power supply line is connected to the P-type contact.

7. The power supply circuit as defined in claim 5,
wherein the N-type well is connected to the drain logic well through an interconnect.

8. The power supply circuit as defined in claim 1,
wherein the step-up circuit is a charge pump.

9. The power supply circuit as defined in claim 8,
wherein the charge pump includes:
second and third switching elements which are connected in series between the first and fourth power supply lines and are driven complementarily;
fourth and fifth switching elements which are connected in series between the second and third power supply lines and are driven complementarily;
a second capacitor connected to a node between the second and third switching elements and a node between the fourth and fifth switching elements; and
a third capacitor connected between the third and fourth power supply lines.

10. The power supply circuit as defined in claim 1,
wherein the first potential is a ground power supply potential (VSS), and the second potential is a logic power supply potential (VDD).

11. The power supply circuit as defined in claim 1, further comprising:
a pre-step-up circuit disposed in a preceding stage of the step-down circuit; and
a fifth power supply line,
wherein the pre-step-up circuit is connected to the first and fifth power supply lines, and supplies the second potential to the second power supply line, the second potential having been obtained by stepping up the first potential by a difference between the first and fifth potentials.

12. The power supply circuit as defined in claim 11,
wherein the pre-step-up circuit is formed of another switching regulator or a charge pump.

13. The power supply circuit as defined in claim 11,
wherein the first potential is a ground power supply potential (VSS), and the fifth potential is a logic power supply potential (VDD).

14. A driver IC, comprising:
the power supply circuit as defined in claim 1; and
a scan line driver section which drives a plurality of scan lines based on a voltage from the power supply circuit.

15. A liquid crystal display device, comprising:
the driver IC as defined in claim 14; and
a liquid crystal display section,
wherein the liquid crystal display section includes:
the plurality of scan lines;
a plurality of data lines; and
a thin film diode and a liquid crystal element connected in series between one of the scan lines and one of the data lines; and
wherein the driver IC is connected to the scan lines of the liquid crystal display section.

16. An electronic instrument comprising the liquid crystal display device as defined in claim 15.
